(19) United States
(12) Patent Application Publication
(10) Pub. No.: US 2022/0343775 A1
(43) Pub. Date: Oct. 27, 2022

(54) DELIVERY DRONE GUIDING SYSTEM AND METHOD

(71) Applicants: Kenneth R. Gillette, Sun City West, AZ (US); Bruce H. Deffler, Sun City West, AZ (US)

(72) Inventors: Kenneth R. Gillette, Sun City West, AZ (US); Bruce H. Deffler, Sun City West, AZ (US)

(21) Appl. No.: 17/728,100

(22) Filed: Apr. 25, 2022

Related U.S. Application Data
(60) Provisional application No. 63/179,008, filed on Apr. 23, 2021.

(51) Int. Cl. G08G 5/00; H04W 4/80

(52) U.S. Cl. CPC G08G 5/0069; H04W 4/80; G08G 5/0026

(57) ABSTRACT

A system and method are disclosed herein. The system communicates with at least one delivery drone over at least one wireless network to accurately guide the at least one delivery drone to a device. The system includes the device, and in some embodiments, a software application/website. The device is preferably installed outside of a home or other building and includes a housing, a display screen, a camera, a motion sensor, at least one location determining module, at least one second communication module and at least one processor. The system utilizes the location determining module and the at least one second communication module to accurately guide one or more delivery drones to an exact location of the device.

### CROSS-REFERENCE TO RELATED APPLICATION(S)

The present application is related to and claims priority to U.S. Provisional Patent Application No. 63/179,008 filed Apr. 23, 2021, which is incorporated by reference herein in its entirety.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### TECHNICAL FIELD

The present invention relates generally to the field of unmanned arial vehicles of existing art and more specifically relates to a system and method for accurately transmitting location information to a delivery drone.

### RELATED ART

A delivery drone is an unmanned aerial vehicle (UAV) used to transport packages, medical supplies, food, or other goods. With the use of autonomous vehicles rising along with the use of robots to perform human jobs rising, the use of these delivery drones is becoming more and more widespread. Further, the use of these delivery drones offers extensive benefits over human delivery, as the delivery drones are able to deliver items quickly, deliver in remote areas difficult to reach by humans, etc. However, because the delivery drones are autonomous, there is a need to communicate with them in order to provide optimal implementation thereof. Particularly, there is a need to communicate a specific location at which the delivery drone must land. This is important as without specific location information, the delivery drones may deliver to a wrong location, creating security issues, may land in an irretrievable location, or the like. As such, a suitable solution is desired.

### SUMMARY OF THE INVENTION

In view of the foregoing disadvantages inherent in the known delivery drone art, the present disclosure provides a novel delivery drone guiding system and method. The general purpose of the present disclosure, which will be described subsequently in greater detail, is to provide a system including a device that is installable in an area about a home or other building and that includes location determining modules and communication modules enabling the broadcast of a geographical location of the device to one or more delivery drones.

A system for communicating with at least one delivery drone over at least one wireless network is disclosed herein. The at least one delivery drone may comprise at least one first communication module. The system may comprise a device including a housing, a display screen, at least one location determining module, at least one second communication module and at least one processor. The housing may include a front section opposite a rear section. The display screen may be attached at the front section of the housing and configured to selectively display information.

The location determining module may be disposed within the housing and configured to receive location information identifying a geographic location of the device. The at least one second communication module may also be disposed within the housing. The at least one second communication module may be configured to communicate with the at least one first communication module over the at least one wireless network and may enable transmission of the geographic location of the device to the at least one delivery drone via the at least one first communication module. The at least one processor may be disposed within the housing and in communication with the display screen, the location determining module and the at least one second communication module.

The device may accurately guide the at least one delivery drone to the geographic location of the device and the at least one second communication module may consistently broadcast the geographic location of the device to the at least one delivery drone during guiding thereof.

According to another embodiment, a method of accurately guiding at least one delivery drone to a device is also disclosed herein. The method includes providing the device as above; receiving, at the at least one second communication module, communication from the at least one delivery drone via the at least one first communication module over the at least one wireless network; determining, via the location determining module, the location information identifying the geographic location of the device; consistently broadcasting, via the at least one second communication module, the geographic location of the device to the at least one delivery drone via the at least one first communication module over the at least one wireless network; and guiding the at least one delivery drone to the geographic location of the device.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a delivery drone guiding system and method, constructed and operative according to the teachings of the present disclosure.

FIG. 1 is a perspective view of a system communicating with at least one delivery drone over at least one wireless network, according to an embodiment of the disclosure.

FIG. 2 is a schematic diagram of the system, according to an embodiment of the present disclosure.

FIG. 3 is a front perspective view of the system including a device having a housing, a display screen and a camera, according to an embodiment of the present disclosure.

FIG. 4 is a front view of the system including display screen showing an address, according to an embodiment of the present disclosure.

FIG. 5 is a front view of the system including display screen showing a message, according to an embodiment of the present disclosure.

FIG. 6 is a schematic diagram of the system illustrating the device communicating with the software application, according to an embodiment of the present disclosure.

FIG. 7 is an exemplary view of a user interface of a software application, according to an embodiment of the present disclosure.

FIG. 8 is an exemplary view of a user interface of a software application, according to an embodiment of the present disclosure.

FIG. 9 is a rear perspective view of the device including a rear section, according to an embodiment of the present disclosure.

FIG. 10 is a rear perspective view of the device including a power cable, according to an embodiment of the present disclosure.

FIG. 11 is a schematic diagram of the system illustrating the device communicating with the at least one delivery drone, according to an embodiment of the present disclosure.

FIG. 12 is a schematic diagram of the system illustrating the device, the at least one delivery drone and a third party server, according to an embodiment of the present disclosure.

FIG. 13 is a flow diagram illustrating a method of accurately directing at least one delivery drone to a device, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to drone delivery and more particularly to a delivery drone guiding system and method. Generally, the delivery drone guiding system and method may include a device and software/a website. A display screen of the device may display a message, code, etc. utilizing alphanumeric characters. For example, the display screen may display an address where the device is located. The delivery drone guiding system and method may utilize GPS and communication module(s) to accurately guide one or more delivery drones to an exact location of the device.

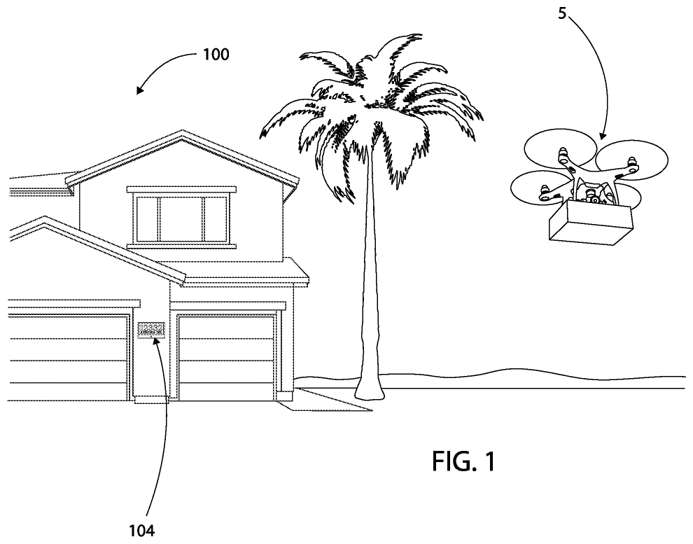

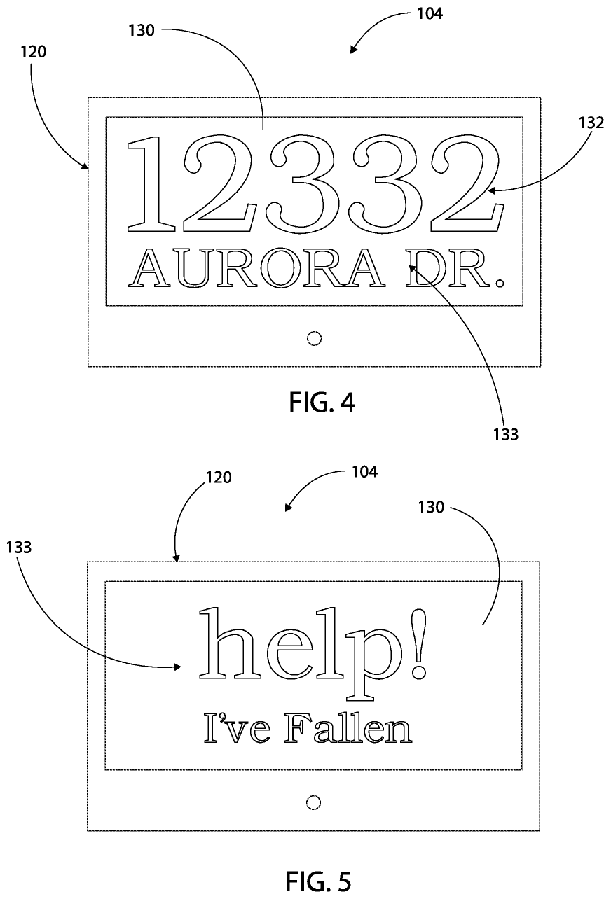

Referring now more specifically to the drawings by numerals of reference, there is shown in FIGS. 1-12, various views of a system 100. The system 100 may include a device 104 and, in some embodiments, a software application 106. As discussed above, the system 100 may be used for communicating with at least one delivery drone 5 over at least one wireless network. Particularly, the device 104 may accurately guide the at least one delivery drone 5 to a geographic location of the device 104. To facilitate this, the at least one delivery drone 5 may comprise at least one first communication module 10. In some examples, the at least one delivery drone 5 may be one delivery drone in which the device 104 is configured to communicate with and guide the delivery drone to its location. In other embodiments, the device 104 may communicate with a plurality of delivery drones at any one given time.

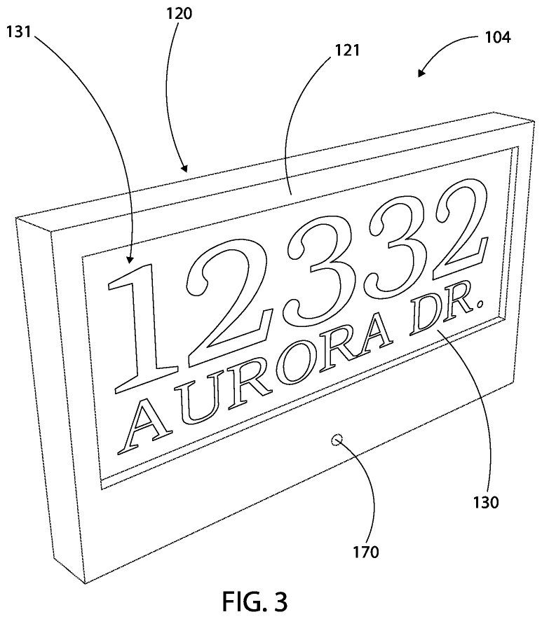

As shown in FIGS. 3-5, the device 104 may include a housing 120, a display screen 130, at least one at least one location determining module 140, at least one second communication module 150 and at least one processor 160. The at least one processor 160 may disposed within the housing 120 and in communication with the display screen 130, the at least one location determining module 140 and the at least one second communication module 150. In some examples, the at least one processor 160 may include (but is not limited to) a 1.4 Ghz-bit quad-core processor.

The housing 120 may include a front section 121 opposite a rear section 122. A circuit board containing the at least one location determining module 140, the at least one second communication module 150 and the at least one processor 160 may be located in the rear section 122 of the housing 120. As such, the rear section 122 of the housing 120 may be removable to enable access to these components if needed. As shown, in some embodiments, the housing 120 may include a rectangular shape (however it should be appreciated that the housing 120 is not limited to the shape or configuration shown). In some embodiments, the housing 120 may be placed outside of a building, such as a home or a commercial building. In some examples, the housing 120 may be attached next to the garage door, as shown in FIG. 1. In other examples, the housing 120 may be placed on a front doorstep.

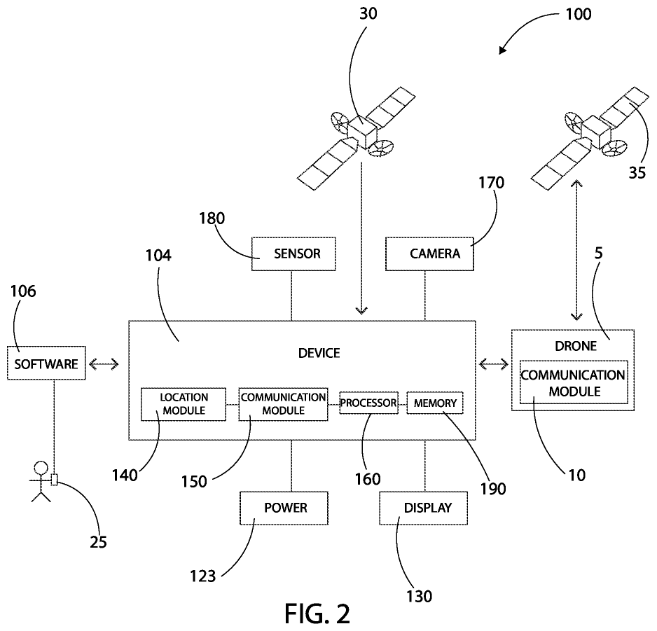

Further, as shown in FIGS. 2-5, the device 104 may include a camera 170 attached about the front section 121 of the housing. The camera 170 may enable the device 104 to capture photos and/or videos of what is in front of the device 104. In some examples, the camera 170 may capture 1024×720-pixel image. Further, in some embodiments, the camera 170 may include a wide angle for capturing a wide view of what is in front of the device 104.

Particularly, the camera 170 may preferably be configured to capture still images and motion video. In some embodiments, the device 104 may include a memory storage 190 for storing an amount of the still images and motion video thereon. For example, the memory storage 190 may be internal to the device 104, or the device 104 may include a port for receiving external memory cards. In other embodiments, the memory storage 190 may include a temporary memory and the device 104 may be configured to transmit the images and video to the software application /website 106. For example, the still images and motion video may be automatically uploaded to and saved on a server, which may be viewed by the user on the software application/website 106 (using an external device 25).

The device 104 may further include a sensor 180 in communication with the camera 170. For example, the sensor 180 may be a motion sensor 180. As such, once motion is sensed by the motion sensor 180, the camera 170 may begin recording an event and the at least one processor 160 may generate and send an alert to the user via text, voice or other notification. For example, the user may receive a push notification on an external device 25. The captured image/video may then again be transmitted to the server and viewable on the software application/website 106 via the external device 25. The captured image/video may include images of the delivery drone, or products that are being delivered, so that the user is alerted once their package has been received. The captured image/video may be compatible with third party cloud-based services like, but not limited to, Amazon Web Services (“AWS”) data services. This may provide long term storage and remote internet playback. Further, via the software application/website 106, a sensitivity of the motion sensor 180 may be adjusted.

As shown in FIGS. 3-5, the display screen 130 may be attached at the front section 121 of the housing 120. To provide protection to the display screen 130 and the components of the housing 120, the housing 120 may be made from a durable and sturdy material. For example, the housing 120 may be made from a plastic material. The housing 120 may further include an aesthetically pleasing appearance, for example, the housing 120 may include various colors various patterns, designs, etc. This may be useful in maintaining a pleasing appearance to the house/building. Further, as the device 104 may be preferably stored outdoors, the housing 120 may be weatherproof and waterproof, comprising seals for preventing water from getting into the circuit board.

The display screen 130 may be configured to selectively display information 131. For example, the information 131 may be a number 132 and/or a message 133 in alphanumeric characters. In some embodiments, the display screen 130 may be sized to display a top line of five (5) alphanumeric characters, and a bottom line of eleven (11) alphanumeric characters. The message 133 may be chosen or written by the user. For example, in some embodiments, the top line may display a house number, and the second line may display a street name, apartment number, etc. In other examples, the display screen 130 may be utilized to display emergency messages such as “help” (as shown in FIG. 5), “SOS”, etc. It should be appreciated that the display is not limited to this number of alphanumeric characters within the display.

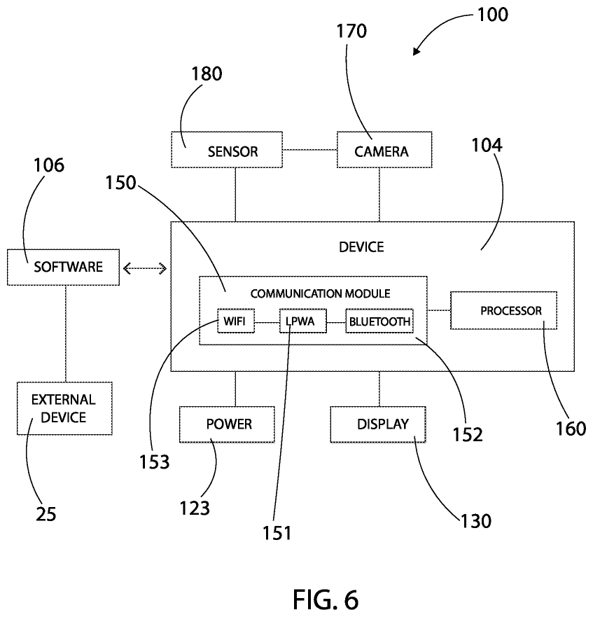

Further, a color of the alphanumeric characters may be selectively altered by the user based on their preference, and a background color of the top line and the second line may be selectively altered by the user based on their preference. For example, the alphanumeric characters may be white, and the background color of the second line may be purple. All configurations may be achieved via the software application 106. For example, the user may utilize an external device 25 to connect with the at least one second communication module 150. In some embodiments, as shown in FIG. 6, particularly, the at least one second communication module 150 may include a WIFI transceiver 153 configured to communicate over a WIFI network. In some embodiments, the WIFI transceiver 153 may communicate with the software application/web site 106 over the WIFI network. In this embodiment, the user may either download or access the software application 106 via the external device 25. For example, the software application 106 may be incorporated into a website accessible with any standard web browser, may be a web application downloadable to a computer, may be a smartphone application downloadable to a smartphone, etc.

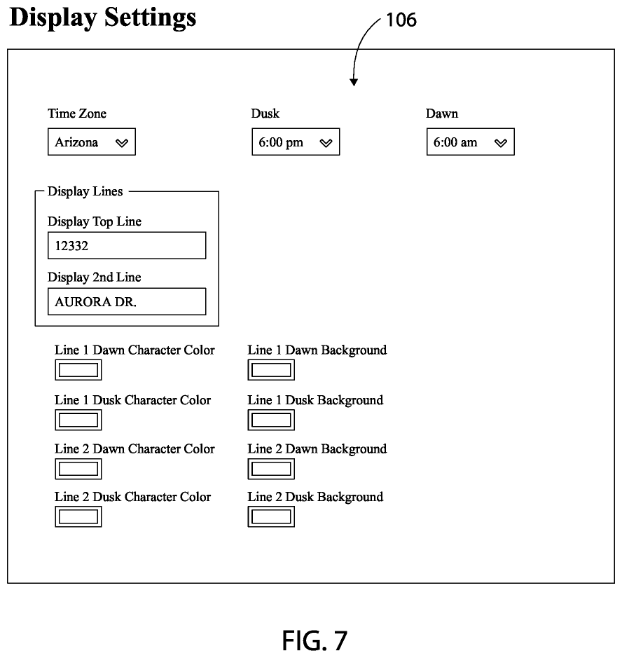

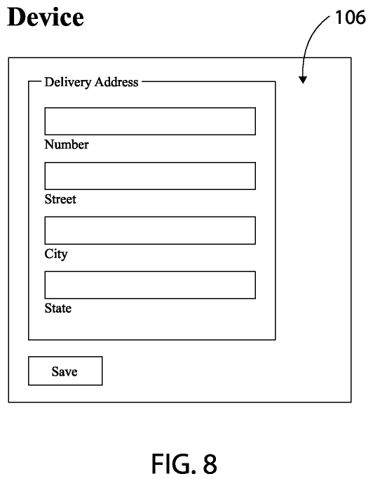

The software application 106 may be configured to transmit user-input commands to the device 104 via the WIFI transceiver 153, as shown in FIGS. 7-8. The user-input commands may be input via keyboard input and/or voice input. For example, the user may type a message into one or both form fields (corresponding to the top line and the second line on the display), and the display screen 130 may then display the message. Similarly, the user may choose a color of the alphanumeric characters and/or the background colors of the lines using the software application/website 106. In some embodiments, the user may choose from a wide selection of colors. For example, the software application/website 106 may allow the user to select from a color wheel. In other embodiments, the user may choose from preset standard colors.

In another example, the user may speak the message 133/number 132 they would like the display screen 130 to display. In this example, a microphone on the external device 25 may be used. Further, in this example, voice recognition software may be used. In some embodiments, this may be third party voice recognition software. Communication between the software application/website 106 and the device 104 may be achieved in real time, or at least substantially in real time, and thus, display of the information 131/colors on the display screen 130 may be nearly instantaneous. This may be particularly useful in emergency situations where the user needs to attract attention quickly.

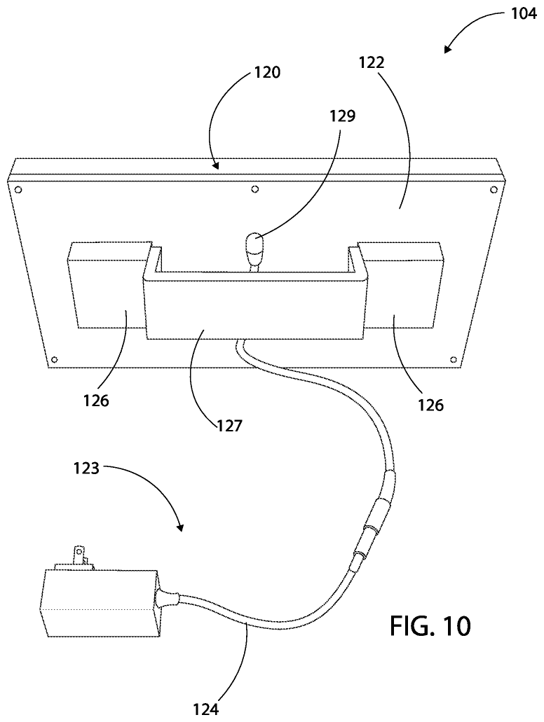

In some embodiments, as shown in FIG. 2 and FIG. 6, the device 104 may include a power supply 123. For example, in some embodiments, as shown in FIG. 10, the device 104 may include a power cable with plug 124 for connecting an outlet inside of the building to supply power to the device 104.

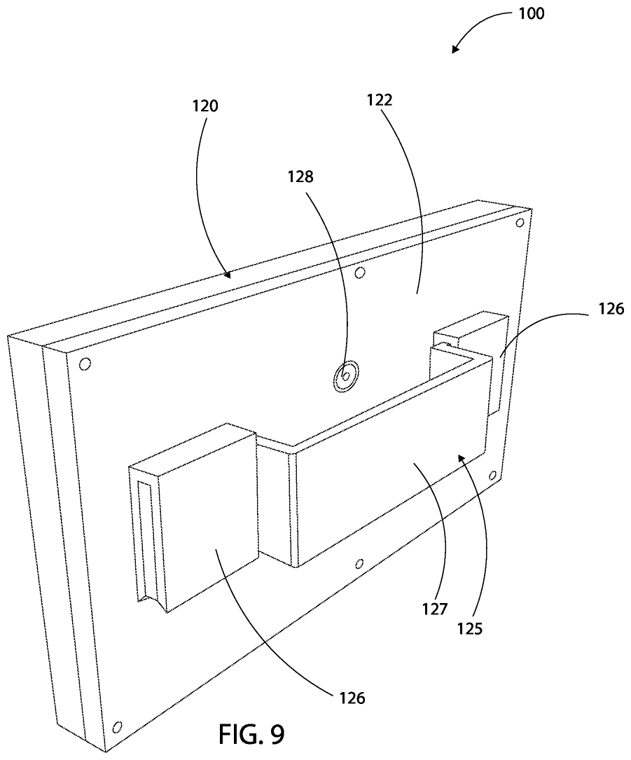

As shown in FIGS. 9-10, the rear section 122 of the housing 120 may include a bracket 125 for attaching the device 104 to the house/building. As shown, the bracket 125 may include a main bracket portion 127 and side clips 126 either side thereof. The main bracket portion 127 may be removable from the housing 120. In some examples, the main bracket portion 127 may be attached to a wall on the house/building and the side clips 126 may slide onto the main bracket portion 127 to attach the housing 120 to the wall. This method of attachment may ensure that the housing 120 remains waterproof.

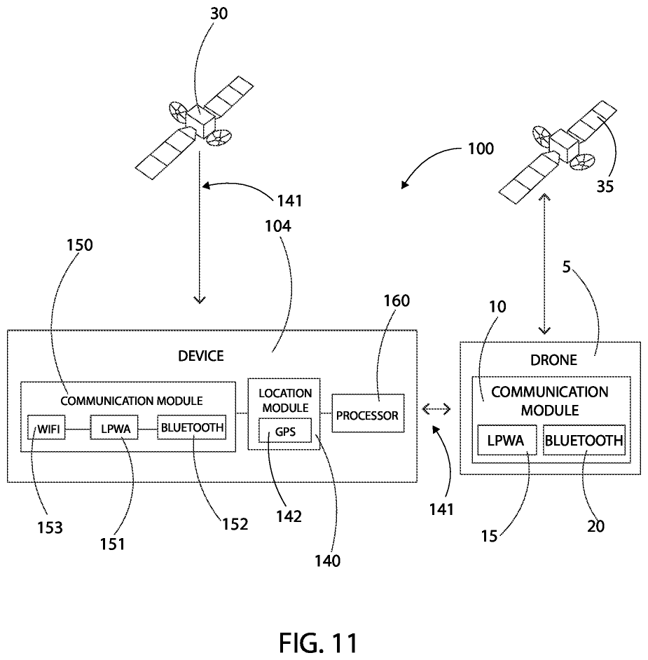

The at least one location determining module 140 may be disposed within the housing 120 and may be configured to receive location information 141 identifying the geographic location of the device 104, as demonstrated in FIG. 11. For example, the location information 141 may be exact latitude and longitude coordinates of the device 104. In some embodiments, the at least one location determining module 140 may be a Global Positioning System (GPS) receiver 142 configured to receive GPS coordinates from GPS satellite(s) 30. The at least one location determining module 140 may also work alongside the at least one second communication module 150 to obtain the most accurate geographic location. For example, the device 104 may also utilize internet reception to enhance GPS positioning information.

Further, in some embodiments, the at least one location determining module 140 may utilize a geocode system, such as “geohashing” to provide the at least one delivery drone 5 with latitude and longitude coordinates of the device 104. In some embodiments, initial location information 141 of the device 104 may be provided by existing geolocation application programming interfaces (“API”) such as GOOGLE® Maps services utilizing the user's address. Additionally, or instead of this, the GPS receiver 142 may provide the initial location information 141. This may be particularly useful for operation in remote locations that do not have internet access.

The at least one second communication module 150 may also be disposed within the housing 120. The at least one second communication module 150 may preferably communicate with the at least one first communication module 10 over the at least one wireless network and enable transmission of the geographic location of the device 104 to the at least one delivery drone 5 (via the at least one first communication module 10). Particularly, the at least one second communication module 150 may consistently broadcasts the geographic location of the device 104 to the at least one delivery drone 5 during guiding thereof.

Preferably, this communication may preferably be performed over long ranges, enabling the device 104 to begin guiding the at least one delivery drone 5 from a far distance. As such, the at least one second communication module 150 and the at least one first communication module 10 communicate via a long distance wireless network. For example, preferably, the device 104 may begin communicating with the at least one delivery drone 5 once the at least one delivery drone 5 has begun its journey to the device 104. This communication range may be aided by the fact that the housing 120 is preferably located outdoors. As such, once the at least one delivery drone 5 gets in range of the device 104 (and the at least one second communication module 150), the at least one second communication module 150 and the at least one first communication module 10 may begin communicating, allowing the at least one second communication module 150 to transmit the geographic location of the device 104 to the at least one first communication module 10, thereby guiding the at least one delivery drone 5 to the device 104.

To facilitate this long range of communication, in some embodiments, as shown in FIG. 11, the at least one second communication module 150 may include a second low-power wide-area transceiver 151 and the at least one second communication module 150 may include a first low-power wide-area transceiver 15. As such, the long distance wireless network may include a second low-power wide-area network. For example, in some embodiments, the second low-power wide-area transceiver 151 and the first low-power wide-area transceiver 15 may include LoRa® transceiver modules communicating via LoRaWAN® network protocol. In some examples, second low-power wide-area transceiver 151 and the first low-power wide-area transceiver 15 may communicate over a 10 mile or greater range.

To further aid in guiding the at least one delivery drone 5, at least one second communication module 150 and the at least one first communication module 10 may also communicate via a short distance wireless network. For example, in some embodiments, the short distance wireless network may be a BLUETOOTH® network. As such, as shown in FIG. 11, the at least one second communication module 150 may further a second BLUETOOTH® transceiver 152 and the at least one first communication module 10 may further includes a first BLUETOOTH® transceiver 20.

In this embodiment, once the at least one delivery drone 5 gets in range of the device 104 (and the second BLUETOOTH® transceiver 152), the second BLUETOOTH® transceiver 152 and the first BLUETOOTH® transceiver 20 may begin communicating. This communication may enable more data to be transmitted and received therebetween, and as such, the location information 141 transmitted by the second BLUETOOTH® transceiver 152 may be more detailed and accurate, thereby enhancing the accuracy when guiding the at least one delivery drone 5 in the final (approximately) 10 meters of the journey.

In some embodiments, the second BLUETOOTH® transceiver may utilize a 16-byte Universally Unique Identifier (UUID) dynamically configured by a geocoding algorithm of the location information 141 (latitude/longitude). The 16-byte UUID may be represented as 32 hexadecimal digits. The UUID may be easily decoded by the at least one delivery drone 5 to validate the geographic location. Once the geographic location is validated, the at least one delivery drone 5 may utilize a signal level provided by the second BLUETOOTH® transceiver 152 to accurately land at the exact geographic location of the device 104. In some embodiments, the at least one second communication module 150 may continuously broadcast a signal (when the device 104 is powered), so that the at least one delivery drone 5 is able to communicate as soon as it gets in range of the at least one second communication module 150.

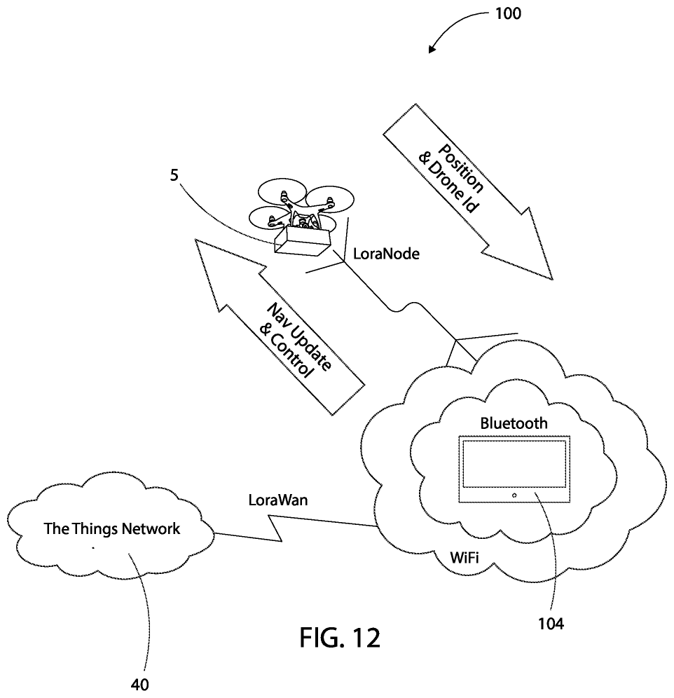

In some embodiments, the device 104 may also utilize hardware to bridge from the at least one drone 5 over LoRaWAN®, building a multi-protocol bridge. Thus, this may enable the at least one drone 5 to update its position and identification first via LoRaWAN® (or another low-power wide-area network) and to get course updates back from the device 104. Once in range of the second BLUETOOTH transceiver 152 the at least one drone may utilize Received Signal Strength Indicator (RSSI) for final approach. The device 104 and the at least one drone 5 may utilize a third party server that enables worldwide drone positioning and identification. For example, if communicating via LoRaWAN®, the third party server 40 may be (but is not limited to) “The Things Stack/Network” as shown in FIG. 12. The device 104 may act as the LoRaWAN® gateway and communication hub. The third party server preferably provides a high level of security and device identification that can be leveraged.

The third party server 40 may provide a unique three tiered sphere of communication for drone collision avoidance and position control. Further, to aid in drone collision avoidance, each drone 5 that is monitoring for RSSI level of a given device 104 may be able to also determine its proximity to another drone 5 in its area and the exact location of the other drone 5 via the geocoded information contained in the device 104. As such, if a second drone is within a certain proximity of a first drone, the second drone may not be able to continue until the first drone has moved away.

In some embodiments, the camera 170 on the device 104 may enable a pilot of the at least one drone 5 (or the at least one drone 5 itself if autonomous) to access internet/video feedback from the camera 170 as shown in FIG. 2. Particularly, wide-band internet and video may be back hauled to the at least one drone 5 via the at least one network. This may act as an added redundancy should any other communication fail. Further, in some embodiments, as shown in FIG. 2 and FIG. 11, the drone communication module 10 may also be configured to communicate with a global connectivity satellite, such as, but not limited to, OMNISPACE® satellite 35. This may provide added redundancy to the system, providing the at least one drone 5 with direct-to-satellite communications over LoRaWAN® network protocol.

In general use, a user may connect the device 104 to a WIFI network in their house or building and install the device 104 in an area outside of their house or building. Then, utilizing an external device 25 such as a smartphone or a laptop, the user may connect to the software application/website 106, either by downloading the software application 106 or accessing the website 106 via a standard web browser. The user may then use the software application/website 106 to enter the information on the display screen 130. When a delivery drone 5 is making a delivery to the house or building, it may receive communication from the device 104 (via the at least one second communication module 150) including the location information 141 of the device 104. The delivery drone 5 may thus be accurately guided by the device 104 to its location.

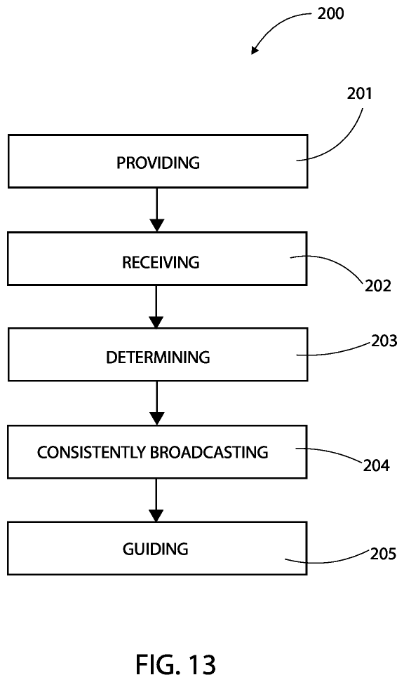

Referring now to FIG. 13, there is shown method 200 of accurately guiding at least one delivery drone to a device. As shown, the method 200 may comprise the steps of: step 201 providing the device 104 (and in some embodiments the software application 106) as above; step 202 receiving, at the at least one second communication module, communication from the at least one delivery drone via the at least one first communication module over the at least one wireless network; step three 203, determining, via the at least one location determining module, the location information identifying the geographic location of the device; step four 204, consistently broadcasting, via the at least one second communication module, the geographic location of the device to the at least one delivery drone via the at least one first communication module over the at least one wireless network; and step five 205, guiding the at least one delivery drone to the geographic location of the device.

Referring now to FIG. 13 showing a flow diagram illustrating a method 200 of accurately guiding at least one delivery drone to a device, according to an embodiment of the present disclosure. In particular, the method 200 may include one or more components or features of the system 100 as described above. As shown, the method 200 may comprise the steps of: step 201 providing the device 104 (and in some embodiments the software application 106) as above; step 202 receiving, at the at least one second communication module, communication from the at least one delivery drone via the at least one first communication module over the at least one wireless network; step three 203, determining, via the at least one location determining module, the location information identifying the geographic location of the device; step four 204, consistently broadcasting, via the at least one second communication module, the geographic location of the device to the at least one delivery drone via the at least one first communication module over the at least one wireless network; and step five 205, guiding the at least one delivery drone to the geographic location of the device.

It should be noted that certain steps may be optional and may not be implemented in all cases. It should also be noted that the steps described in the method can be carried out in many different orders according to user preference. The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods for guiding delivery drones to a device are taught herein.

Those with ordinary skill in the art will now appreciate that upon reading this specification and by their understanding the art of drone delivery, low-power-wide-range communication, short-range communication, etc. as described herein, methods of guiding delivery drones via low-power-wide-range communication and other communication modules will be understood by those knowledgeable in such art.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A system for communicating with at least one delivery drone over at least one wireless network, the at least one delivery drone comprising at least one first communication module, the system comprising:
a device including:
a housing including a front section opposite a rear section;
a display screen attached at the front section of the housing, the display screen configured to selectively display information;
at least one location determining module disposed within the housing, the location determining module configured to receive location information identifying a geographic location of the device;
at least one second communication module disposed within the housing, the at least one second communication module configured to communicate with the at least one first communication module over the at least one wireless network, the at least one second communication module enabling transmission of the geographic location of the device to the at least one delivery drone via the at least one first communication module;
at least one processor disposed within the housing and in communication with the display screen, the location determining module and the at least one second communication module; and,
wherein the device accurately guides the at least one delivery drone to the geographic location of the device; and,
wherein the at least one second communication module consistently broadcasts the geographic location of the device to the at least one delivery drone during guiding thereof.

2. The system of claim 1, wherein the at least one second communication module and the at least one first communication module communicate via a long distance wireless network.

3. The system of claim 2, wherein the at least one second communication module includes a second low-power wide-area transceiver, wherein the at least one second communication module includes a first low-power wide-area transceiver, and wherein the long distance wireless network includes a second low-power wide-area network.

4. The system of claim 3, wherein the at least one second communication module and the at least one first communication module further communicate via a short distance wireless network.

5. The system of claim 4, wherein the at least one second communication module further includes a second BLUETOOTH transceiver, wherein the at least one first communication module further includes a first BLUETOOTH transceiver, and wherein the short distance wireless network includes a BLUETOOTH network.

6. The system of claim 5, wherein the at least one second communication module further includes a WIFI transceiver configured to communicate over a WIFI network.

7. The system of claim 6, further comprising a software application useable on an external device, wherein the WIFI transceiver communicates with the software application over the WIFI network, and wherein the software application is configured to transmit user-input commands to the device via the WIFI transceiver.

8. The system of claim 1, wherein the user-input commands include at least adjusting the information displayed on the display screen, and wherein the user-input commands are input via at least one of keyboard input and voice input.

9. The system of claim 8, wherein the information is at least one of a number and a message.

10. The system of claim 9, wherein the device further comprises a camera attached about the front section of the housing.

11. A method of accurately guiding at least one delivery drone to a device, the at least one delivery drone comprising at least one first communication module, the method comprising the steps of:
providing the device, the device including:
a housing including a front section opposite a rear section;
a display screen attached at the front section of the housing, the display screen configured to selectively display information;
at least one location determining module disposed within the housing, the location determining module configured to receive location information identifying a geographic location of the device;
at least one second communication module disposed within the housing, the at least one second communication module configured to communicate with the at least one first communication module over the at least one wireless network, the at least one second communication module enabling transmission of the geographic location of the device to the at least one delivery drone via the at least one first communication module;
at least one processor disposed within the housing and in communication with the display screen, the location determining module and the at least one second communication module;
receiving, at the at least one second communication module, communication from the at least one delivery drone via the at least one first communication module over the at least one wireless network;
determining, via the location determining module, the location information identifying the geographic location of the device;
consistently broadcasting, via the at least one second communication module, the geographic location of the device to the at least one delivery drone via the at least one first communication module over the at least one wireless network; and
guiding the at least one delivery drone to the geographic location of the device.

12. The method of claim 11, wherein the at least one second communication module and the at least one first communication module first communicate via a long distance wireless network.

13. The method of claim 12, wherein the at least one second communication module includes a second low-power wide-area transceiver, wherein the at least one second communication module includes a first low-power wide-area transceiver, and wherein the long distance wireless network includes a second low-power wide-area network.

14. The method of claim 13, wherein the at least one second communication module and the at least one first communication module secondly communicate via a short distance wireless network.

15. The method of claim 14, wherein the at least one second communication module further includes a second BLUETOOTH transceiver, wherein the at least one first communication module further includes a first BLUETOOTH transceiver, and wherein the short distance wireless network includes a BLUETOOTH network.

16. The method of claim 15, wherein the at least one second communication module further includes a WIFI transceiver configured to communicate over a WIFI network.

17. The method of claim 11, further comprising a software application useable on an external device, wherein the WIFI transceiver communicates with the software application over the WIFI network, and wherein the software application is configured to transmit user-input commands to the device via the WIFI transceiver.

18. The method of claim 17, wherein the user-input commands include at least adjusting the information displayed on the display screen, and wherein the user-input commands are input via at least one of keyboard input and voice input, and wherein the information is at least one of a number and a message.

19. The method of claim 18, wherein the device further comprises a camera attached about the front section of the housing.

20. A system for communicating with at least one delivery drone, the at least one delivery drone comprising a first low-power wide-area transceiver and a first BLUETOOTH transceiver, the system comprising:
a device including:
a housing including a front section opposite a rear section;
a display screen attached at the front section of the housing, the display screen configured to selectively display information, the information including at least one of a number and a message;
a camera attached about the front section of the housing;
at least one location determining module disposed within the housing, the location determining module configured to receive location information identifying a geographic location of the device;
a WIFI transceiver module disposed within the housing, the WIFI transceiver configured to communicate over a WIFI network;
a second low-power wide-area transceiver disposed within the housing, the second low-power wide-area transceiver configured to communicate with the first low-power wide-area transceiver over a low-power wide-area network, thereby enabling transmission of the geographic location of the device to the at least one delivery drone via the at least one first low-power wide-area transceiver;
a second BLUETOOTH transceiver disposed within the housing, the second BLUETOOTH transceiver configured to communicate with the first BLUETOOTH transceiver over a BLUETOOTH network, thereby enabling transmission of the geographic location of the device to the at least one delivery drone via the first BLUETOOTH transceiver;
at least one processor disposed within the housing and in communication with the display screen, the camera, the location determining module, the WIFI transceiver, the second low-power wide-area transceiver and the second BLUETOOTH transceiver;
wherein the device accurately guides the at least one delivery drone to the geographic location of the device; and
wherein at least the second low-power wide-area transceiver consistently broadcasts the geographic location of the device to the at least one delivery drone during guiding thereof; and
a software application useable on an external device, the software application being configured to communicate with the WIFI transceiver over the WIFI network and transmit user-input commands to the device via the WIFI transceiver, the user-input commands include at least adjusting the information displayed on the display screen, the user-input commands being input via at least one of keyboard input and voice input.
